(19) United States
(12) Patent Application Publication
(10) Pub. No.: US 2018/0046703 A1
(43) Pub. Date: Feb. 15, 2018

(54) STAGED SEARCH QUERY AND SEARCH CATEGORY FORMULATION

(71) Applicant: Twiggle Ltd., Tel-Aviv (IL)

(72) Inventors: Avishay LAVIE, Tel-Aviv (IL); Noa GANOT, Givataim (IL); Eli SHALOM, Tel-Aviv (IL); Ido MOSHE, Givataim (IL); Lior STERNBERG, Kfar Yedidya (IL); Natalya CHUCHINSKY, Tel-Aviv (IL); Deborah Alexandra LALOUM, Tel-Aviv (IL)

(21) Appl. No.: 15/234,266

(22) Filed: Aug. 11, 2016

(51) Int. Cl. G06F 17/30

(52) U.S. Cl. CPC G06F 17/30643; G06F 17/3071

(57) ABSTRACT

A system and method including receiving from a user machine a text input inserted as search input into a search input interface, providing the user machine at least one search category suggestion obtained from hierarchic data structure of search categories, once a suggested search category is selected, adding an indication of the selected search category to the search input, and providing at least one additional search category suggestion by filtering suggested search categories according to previously selected search categories included in the search input.

### FIELD AND BACKGROUND OF THE INVENTION

Some known auto-suggestion search query mechanisms suggest a list of independent suggestions based on user input existing in the query field. Such auto suggestion mechanisms usually rely on aggregation of previous searches to learn, for example, the most probable query that contains similar words and/or word prefixes to the user input.

Some other search mechanisms transform the user input into pre-defined structured elements after the search query is submitted, and find results according to the structured elements, while leaving out user input that doesn't match the pre-defined structured elements.

### SUMMARY OF THE INVENTION

According to an aspect of some embodiments of the present invention there is provided a system including a processor configured to execute code for: receiving from a user machine a text input inserted as search input into a search input interface, providing to the user machine at least one search category suggestion obtained from hierarchic data structure of search categories, once a suggested search category is selected, adding an indication of the selected search category to the search input, and providing at least one additional search category suggestion consistent with previously selected search categories included in the search input, by filtering suggested search categories according to previously selected search categories included in the search input.

In some embodiments of the present invention, the system further including a search server configured to receive from the user machine a search query including text input and at least one selected search category from the hierarchic data structure of search categories, conduct a free text search based on the free text input, and use the at least one selected search category to produce a consistent list of search results.

In some embodiments of the present invention, the processor is further configured to submit the contents of the search input to the search server upon every update of the search input, without interruption to a continued query formulation process.

In some embodiments of the present invention, the processor is further configured to submit the contents of the search input to the search server every pre-determined period of time, without interruption to a continued query formulation process.

In some embodiments of the present invention, the processor is configured to execute code for obtaining candidate search category suggestions from a category lexicon consisting of the categories included in the hierarchic data structure.

In some embodiments of the present invention, the processor is configured to execute code for filtering the candidate suggestions based on search categories included in the search input, to obtain category suggestions consistent with the included search categories.

In some embodiments of the present invention, the consistent category suggestions are linked in the hierarchic data structure to the categories included in the search input.

In some embodiments of the present invention, the processor is further configured to execute code for presenting the category suggestions along with respective visual indications about a category type of the suggested search category.

In some embodiments of the present invention, the processor is further configured to execute code for presenting a selected category along with a respective visual indication about a category type of the selected search category.

In some embodiments of the present invention, the processor is further configured to execute code for updating the search input by replacing corresponding free text with a selected category, once a suggested category is selected.

In some embodiments of the present invention, the processor is configured to execute code for extracting new search categories from a target database, and to add the new search categories to the hierarchic data structure.

In some embodiments of the present invention, the processor is configured to execute code for: identifying separate terms in a text related to an item presented in a website, and for each separate term calculating a frequency in which the term appears in the website in relation to the pre-defined search categories, and adding terms with a frequency above a pre-defined threshold to the hierarchic data structure as new search categories in relation to the pre-defined search categories.

According to an aspect of some embodiments of the present invention there is provided a method including: receiving from a user machine a text input inserted as search input into a search input interface, providing to the user machine at least one search category suggestion obtained from hierarchic data structure of search categories, once a suggested search category is selected, adding an indication of the selected search category to the search input, and providing at least one additional search category suggestion by filtering suggested search categories according to previously selected search categories included in the search input.

According to an aspect of some embodiments of the present invention there is provided a processor configured to execute a code for: identifying separate terms in a text related to an item presented in a website, and for each separate term calculating a frequency in which the term appears in the website in relation to a pre-defined search category, and adding to a database terms with a frequency above a pre-defined threshold as new search categories in relation to the pre-defined search categories.

According to an aspect of some embodiments of the present invention there is provided a method including: identifying separate terms in a text related to an item presented in a website, and for each separate term calculating a frequency in which the term appears in the website in relation to a pre-defined search category, and adding to a database terms with a frequency above a pre-defined threshold as new search categories in relation to the pre-defined search categories.

According to an aspect of some embodiments of the present invention there is provided a graphical user interface (GUI) for formulating a search query, the GUI including: a search input interface to receive text input and selected search categories; and a suggestion field configured to display and to receive a command for selection of at least one search category suggestions obtained from hierarchic data structure of search categories, wherein the at least one search category suggestions are consistent with search categories included in the search input field, wherein the search input field is configured to display a selected suggested search category along with an indication of a corresponding category type based on the hierarchic data structure.

In some embodiments of the present invention, the suggestion field is configured to display each of the at least one search category suggestions along with an indication of a corresponding category type based on the hierarchic data structure.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A, 1B and 1C are schematic illustrations of a graphical user interface for enhanced search formulation, according to some embodiments of the present invention;

FIG. 2 is a schematic illustration of an exemplary segment of hierarchic data structure of categories according to some embodiments of the present invention;

FIG. 3 is a schematic flowchart illustrating a method for search query formulation according to some embodiments of the present invention;

FIG. 4 is a schematic illustration of a system for search query formulation according to some embodiments of the present invention;

FIG. 5 is a schematic flowchart illustrating a method for search query interpretation according to some embodiments of the present invention;

FIG. 6 is a schematic flowchart illustrating a method for creation of search categories according to some embodiments of the present invention; and

FIG. 7 is a schematic illustration of a graphical user interface according to some embodiments of the present invention.

### DESCRIPTION OF SPECIFIC EMBODIMENTS OF THE INVENTION

Some embodiments of the present invention enable a dynamic staged formation of a search query. According to some embodiments, a user inserts free text input into a search interface and receives term suggestions for continuing the search query. The term suggestions are provided from a lexicon of terms representing pre-defined search categories. A search category, as used herein, is a search tool used for filtering search results according to a type and/or an attribute of an item. Hierarchy relations between search categories are defined by a hierarchic data structure.

During composition of a search query, selected search categories are used for filtering the search term suggestions according to the hierarchy relations between the search categories.

As used herein, a search interface, a search GUI or a search input interface may be an interface for collection of search query input. The interface may include a combined search input interface, which may receive free text as well as other input, such as a selection of a choice. Accordingly, the interface may include a search input field, a selection field, a drop-down list, a selection object, a combo box, and/or any other suitable input collection tool.

After a user selects a term suggestion, further suggestions for a continued formation of the search query are provided. The obtaining of the term suggestions depends on categories already included in the search query, based on a pre-defined hierarchic category structure.

The formation of the search query may continue by suggesting terms and selection of terms by the user and/or insertion of further free text, until the user is satisfied with the formed search query. The continued formation of the search query, in some embodiments, is performed in real time, wherein the suggestions are presented and updated instantly upon insertion of input by the user, thus providing a smooth feedback process that improves the accuracy of the search.

According to some embodiments of the present invention, the search query may include pre-defined structured categories along with free text. The search server provided by some embodiments may filter a search space according to the categories included in the query, and perform free text search within the filtered search space, in order to obtain search results. Accordingly, in some embodiments of the present invention, the search server uses both structured categories and free text in order to interpret the query and obtain more accurate search results.

According to further embodiments of the present invention, new search terms are extracted from titles and/or text segments related to database items, by identifying in the titles and/or text segments terms that are used frequently for description of the respective items and adding them to the hierarchic category structure.

Therefore, the system and methods provided by some embodiments of the present invention significantly improves the performance of searchable database systems. For example, the provided system and methods enable time-efficient search sessions, thus reducing the burden on search servers and the computational power consumption.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

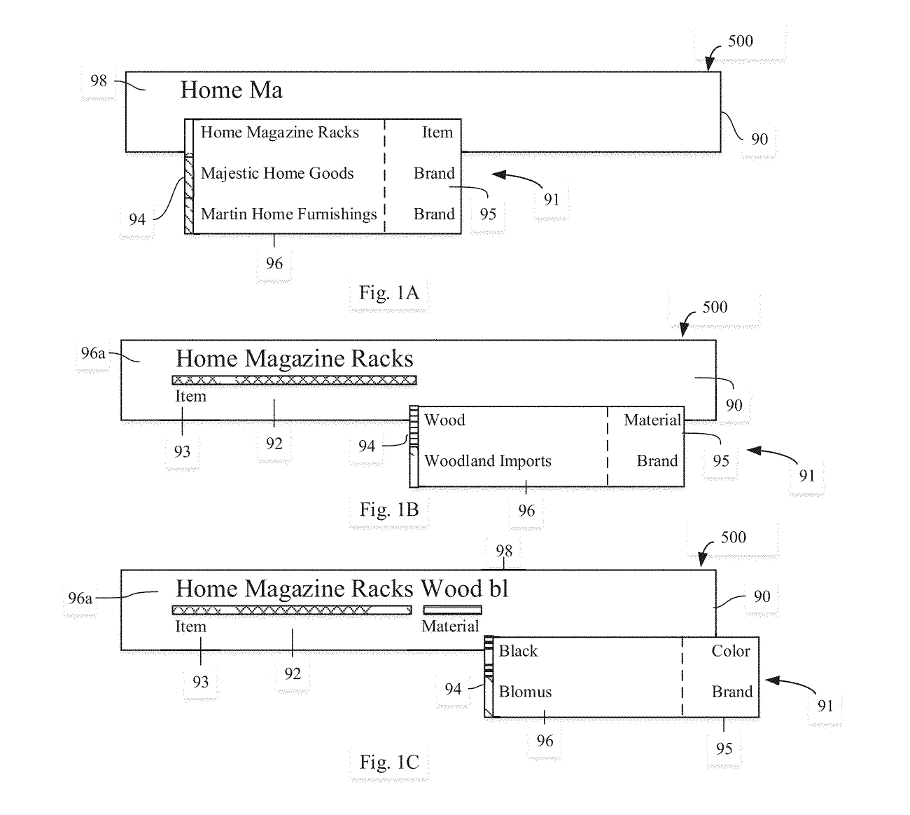

According to some embodiments of the present invention, a user may conduct a database search by a dedicated graphical user interface (GUI), which may enable a structured multi-stage search, for better interpretation of the search and accuracy of the results. Reference is now made to FIGS. 1A-1C, which are schematic illustrations of a search GUI 500 for enhanced search formulation, according to some embodiments of the present invention.

GUI 500 may be included in a website presenting items for viewing and/or for sale, such as, for example, an online store or another online selling platform, a provider's catalog, a catalog of a gallery, museum or library, or any other suitable website, presenting items related to various categories. The user may search, for example, for an item of certain kind and/or with certain features.

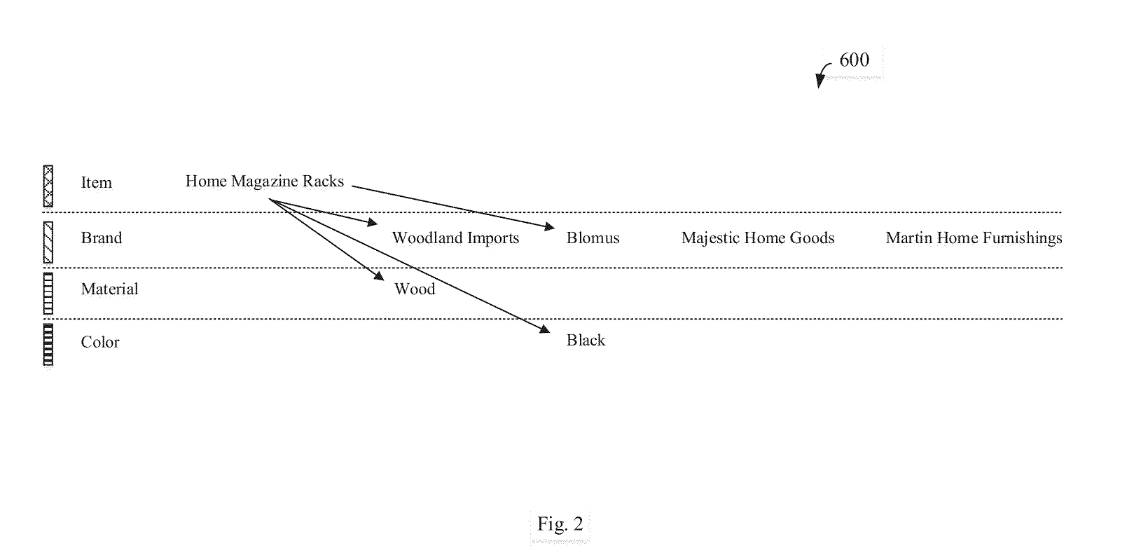

In some embodiments of the present invention, GUI 500 utilizes a hierarchic data structure of categories and sub-categories, as described in more detail herein. Reference is now made to FIG. 2, which is a schematic illustration of an exemplary segment 600 of hierarchic data structure of categories according to some embodiments of the present invention. In the hierarchic data structure, search categories and sub-categories are ordered in a hierarchic structure, as described in detail herein. For example, categories may be ordered according to the type of the category, such as, for example, product category, brand, technical feature, material, color, and or any other suitable type of category. For example, categories of relatively high hierarchy level may include relatively wide definitions of kinds of items.

Therefore, a high level category, such as “Home Magazine Racks”, may usually refer to a large amount of items. Items related to a high level category may be linked to various sub-categories of lower hierarchy levels, such as, for example, specific brands or features, such as, as shown for example in FIG. 2, the brand categories “Woodland Imports” and “Blomus”, the material category “Wood”, the color category “Black”, and/or any other suitable categories. Items related to a certain category of a lower hierarchy level may be linked to sub-categories of further lower hierarchy level, or other categories of the same or higher hierarchy level, such as a specific color, a specific size and/or any other suitable lower level categories, and so on. For example, as shown in FIG. 2, the material category “Wood” may be linked to the product category “Home Magazine Racks”, which is also linked to the color category “black”, to the brand category “Woodland Imports”, and/or to additional suitable categories. The category types, such as “Product”, “Brand”, “Material” and “Color”, may be associated with respective visual indicators 94, for example a different color and/or texture for each category type.

GUI 500 may include a text input field 90 and a suggestion selection field 91. During operation, as shown in FIG. 1A, text input field 90 may receive text input 98 inserted by a user and/or by any suitable input device. For example, the user may enter a text for a search query in a database of the website. As text is inserted into text input field 90, suggestion selection field 91 may automatically display category suggestions 96 consistent with the contents of text input field 90, for adding category information to the search query. The added category information may be used for enhancing the interpretation of the search query, is described in more detail herein.

Suggestions 96 may be automatically extracted from a category lexicon stored in a database, consisting of the categories included in the hierarchic data structure, as described in more detail herein below. A category or sub-category included in the data structure may be a general product category, a brand, a material, a technical feature, a color and/or any other suitable type of categories. A sub-category as used herein means a category of a lower hierarchy relative to another category, and the terms category and sub-category may be used interchangeably throughout this description according to the respective context.

As shown in FIG. 1A, in some embodiments of the present invention, each of category suggestions 96 is displayed along with a visual indication of the corresponding category type, based on the hierarchic data structure. For example, the indication may include a text indication 95 of the category type's name, a different color/texture indication 94 for each category type, and/or any other suitable visual indication. In some embodiments of the present invention, along with a category suggestion, field 91 may display an expected number of search results the suggested category may yield.

Suggestion selection field 91 may receive a command for selection of a category suggestion 96, for example by a mouse, touch, keyboard command, or any other suitable method. As shown in FIG. 1B, once a category suggestion is selected, the selected category 96a may be added to input field 90, for example instead of a corresponding previously typed text 98 that caused the selected suggestion. Selected category 96a may be displayed along with a visual indication of the corresponding category type, such as a text indication 93 of the category type's name, a different color/texture indication 92 for each category type, and/or any other suitable visual indication.

As shown in FIGS. 1B and 1C, once a selected category 96a is added and/or additional text is inserted into text input field 90, suggestion selection field 91 may automatically display further category suggestions 96 consistent with the contents of text input field 90, i.e. with selected categories 96a and/or with additional text 98, according to the hierarchic category data structure. For example, in case the category type of the selected category 96a is “Product”, e.g. product name or general product category, as shown in FIG. 1B, the suggested categories 96 may be of linked category types to the selected category 96a in the hierarchic data structure, such as material, brand, color, technical feature, or any other suitable category type that may be consistent with the type of the selected category. For example, in case the category types of the selected categories 96a is “Product” and “material”, as shown in FIG. 1C, the suggested categories 96 may be of linked category types to the selected category 96a in the hierarchic data structure, such as brand, color, technical feature, or any other suitable category type that may be consistent with the type of the selected category.

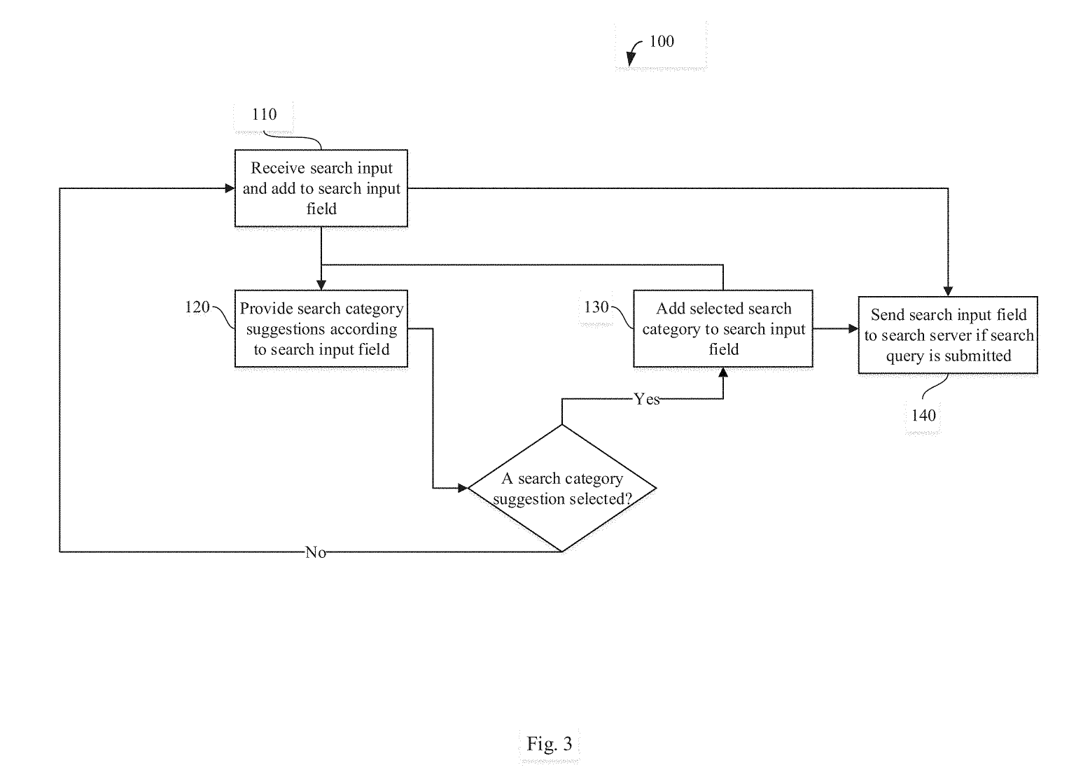

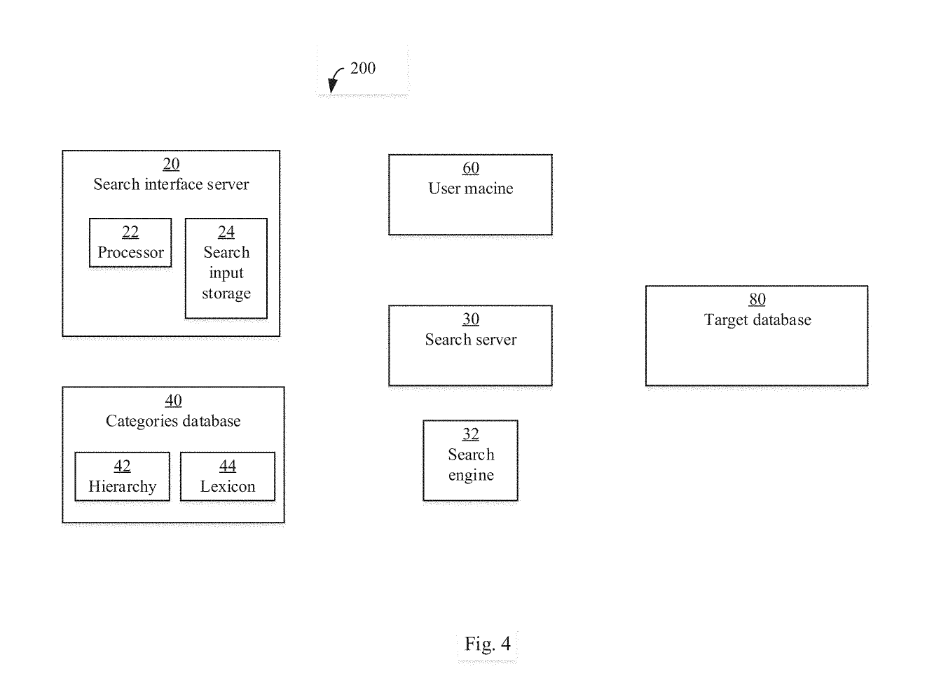

GUI 500 may be activated by a search query interpretation method as provided by some embodiments of the present invention. Reference is now made to FIG. 3, which is a schematic flowchart illustrating a method 100 for search query formulation according to some embodiments of the present invention. Reference is further made to FIG. 4, which is a schematic illustration of a system 200 for search query formulation according to some embodiments of the present invention. System 200 may include a search interface server 20, a categories database 40 and a search server 30.

According to some embodiments of the present invention, a user may conduct by a user machine 60 a database search in a target database 80, in order to find in a target database 80 items of a certain kind and/or with certain features. In some embodiments of the present invention, target database 80 is a database of, for example, an online store or a catalog or any other suitable website, presenting items related to various categories.

During operation, search interface server 20 may receive from user machine 60 a text input, for example free text search input typed by a user as a search query, for example into input field 90 of GUI 500 described in detail above. The received text input may be stored in input field storage 24. Input field storage 24 may be, for example, a constantly updateable code segment and/or file storing data and/or text, reflecting the contents of input field 90 and/or of search GUI 500. As indicated in block 110, upon receiving of the text input typed into input field 90, a processor 22 of search interface server 20 may add the free text input to input field storage 24. As described in more detail below, processor 22 may also store in input field storage 24 search categories selected by a user. A search category, according to some embodiments of the present invention, is a search filter for selecting as search results items pre-defined as related to the category.

Categories database 40 may include a lexicon 44, for example a list or table of pre-defined search categories of items included in a target database 80. Categories database 40 may include hierarchic data structure 42, in which the search categories of items are ordered in a hierarchic structure, as described in detail herein.

According to some embodiments of the present invention, as indicated in block 120, processor 22 provides to user machine 60 suggested search categories, according to the contents of input field storage 24, from which a user may select a suggested search category. As indicated in block 130, once a suggested search category is selected, processor 22 may add the selected search category to the input field 90 and/or update input field storage 24 accordingly, and/or provide further suggestions for display in suggestion field 91, as described in more detail herein.

According to some embodiments of the present invention, based on the received free text input, processor 22 obtains from lexicon 44 candidate categories with spelling and/or prefix at least partially similar to the free text input. In some embodiments, the candidate categories may be similar to a word/prefix in the input and/or to re-ordered words/prefixes in the free text input. Then, in case input field storage 24 includes search categories, processor 22 may use hierarchic data structure 42 to filter, from the candidate categories, category suggestions consistent with search categories included in the input field. For example, the consistent category suggestion may be linked in hierarchic data structure 42 to the categories included in input field storage 24.

According to some embodiments, processor 22 provides the consistent category suggestions to user machine 60, which may, for example, present the suggestions to a user in suggestion selection field 91. The user may select a suggested category and/or continue typing free text and/or submit the search query. In case the user selects a suggested category, the selected category is added to input field 90 and/or input field storage 24 is updated, for example, by replacing corresponding free text with the selected category. Once a search query is submitted to search server 30, as indicated in block 140, the contents of input field storage 24 is sent to search server 30, which may interpret the query and/or filter the search results according to the categories included in input field storage 24 and perform search in target database 80 accordingly, as described in more detail herein. In some embodiments of the present invention, the contents of input field storage 24 may be submitted automatically to search server 30 upon an update of input field storage 24 and/or every pre-determined period of time, without interruption to a continued query formulation process.

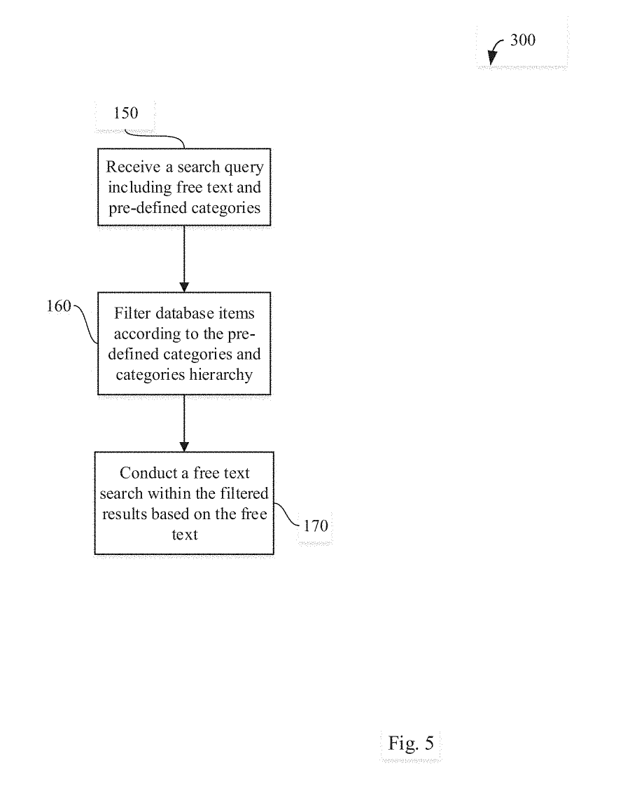

Reference is now made to FIG. 5, which is a schematic flowchart illustrating a method 300 for search query interpretation according to some embodiments of the present invention. As indicated in block 150, search server 30 may receive the contents of input field storage 24 as a search query. As described herein, input field storage 24 may include the selected pre-defined categories and/or free text input.

As indicated in block 160, according to the pre-defined categories included in input field storage 24, search server 30 may operate search engine 32 to apply corresponding filters on target database 80, for example according to the hierarchic data structure 42. Thus, for example, search server 30 may obtain filtered search space of items related to the pre-defined categories included in input field storage 24. As indicated in block 170, in case input field storage 24 includes free text, search server 30 may operate search engine 32 to conduct a free text search within the filtered search space based on the free text included in input field storage 24, thus, for example, obtaining a list of search results. The list of search results may be sent by search server 30 to user machine 60 for presentation to a user. In some embodiments, the free text search may be performed on portions of the input not identified as categories by the search server. In other embodiments, the free text search may be performed on the original free text input, within the filtered search space.

Search server 30 may rank the search results and/or assign scores to the search results, for example according to popularity and/or quality of the products and/or any other suitable criterion. In some embodiments of the present invention, additionally or alternatively to applying filters, search server 30 may use some or all of the selected categories for boosting search results of a free text search, which include the selected categories. For example, search server 30 may provide a higher score for such results and/or present these results higher in the results list. In some embodiments, some of the categories are used as filters as described herein, and some are used for boosting of search results.

In some embodiments of the present invention, target database 80 is a database of an online store or a catalog or another website presenting items in various categories, for example items for sale. In some embodiments of the present invention, the website related to database 80 may present selling offers from users, offering items for sale. The offers may include for example, an image of the item, a description of the item, a title of the selling offer, a price, and/or any other suitable information.

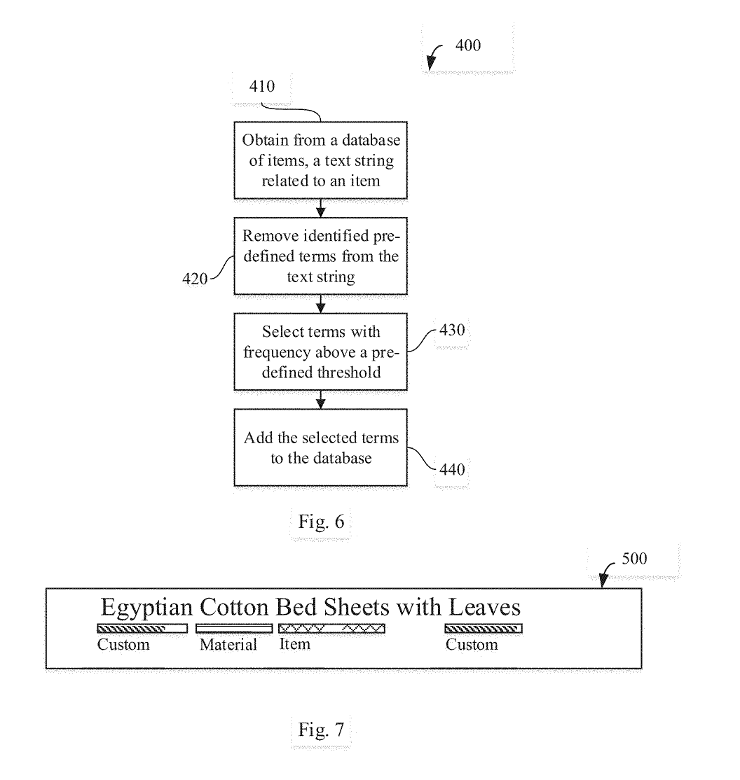

Some embodiments of the present invention enable creation of new search categories and adding the new search categories to categories database 40 and in particular to hierarchic data structure 42. Reference is now made to FIG. 6, which is a schematic flowchart illustrating a method 400 for creation of search categories according to some embodiments of the present invention. As indicated in block 410, processor 22 may obtain, for example from a website or from target database 80, a text segment related to an item presented in the website. For example, processor 22 may scan the target database and/or use a web crawler or any other suitable mechanism for obtaining the text segments related to items in the website.

For example, the text segment may be a title or a description related to the item. As indicated in block 420, processor 22 may identify in the text segment pre-defined terms stored in categories database 40 and remove the identified pre-defined terms from the text segment, to obtain a reduced text segment. As indicated in block 430, processor 22 may calculate a frequency in which each separate term in the reduced text segment appears in the database and/or the website, and select the terms having a frequency above a pre-defined threshold. For example, processor 22 may select terms which appear in at least a certain percentage of the items in a certain product category, such as 3%, 5%, 10% or any other suitable percentage. For example, processor 22 may compare the frequency of appearance of a term in a certain product category to the frequency appearance of the term in the entire target database, and select items which are much more frequent in this category than in the entire database, for example at least 1.5 times or twice more frequent, or any other suitable number of times more frequent. The exact thresholds are chosen based on the characteristics of the specific database.

As indicated in block 430, processor 22 may add the selected terms to the database 40 and to hierarchic data structure 42 as custom categories in hierarchic relations and/or linked to pre-defined terms that were previously identified by the processor in the same text segment. Processor 22 may deduce relations of the selected terms to pre-defined terms and/or categories by finding items which are much more frequent in a certain category than in the entire database, as described above. The most statistically-frequent terms in a category can be linked to that category in the hierarchic structure and used as category suggestions in relation to that category.

The new added categories may be used for formulation of a more time-efficient search process, interpretable accurately by search server 30. For example, reference is now made to FIG. 7, which is a schematic illustration of a GUI 500 according to some embodiments of the present invention. Once custom categories 97 are obtained, custom categories 97 may be suggested by processor 22 and selected by the user similarly to other categories stored in hierarchic data structure 42 as described in detail herein above.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system comprising a processor configured to execute code for:
receiving from a user machine a text input inserted as search input into a search input interface;
providing to the user machine at least one search category suggestion obtained from hierarchic data structure of search categories;
once a suggested search category is selected, adding an indication of the selected search category to the search input; and
providing at least one additional search category suggestion consistent with previously selected search categories included in the search input, by filtering suggested search categories according to previously selected search categories included in the search input.

2. The system of claim 1, further comprising a search server configured to receive from the user machine a search query including text input and at least one selected search category from the hierarchic data structure of search categories, conduct a free text search based on the free text input, and use the at least one selected search category to produce a consistent list of search results.

3. The system of claim 2, wherein the processor is further configured to submit the contents of the search input to the search server upon every update of the search input, without interruption to a continued query formulation process.

4. The system of claim 2, wherein the processor is further configured to submit the contents of the search input to the search server every pre-determined period of time, without interruption to a continued query formulation process.

5. The system of claim 1, wherein the processor is configured to execute code for obtaining candidate search category suggestions from a category lexicon consisting of the categories included in the hierarchic data structure.

6. The system of claim 5, wherein the processor is configured to execute code for filtering the candidate suggestions based on search categories included in the search input, to obtain category suggestions consistent with the included search categories.

7. The system of claim 1, wherein the consistent category suggestions is linked in the hierarchic data structure to the categories included in the search input.

8. The system of claim 1, wherein the processor is further configured to execute code for presenting the category suggestions along with respective visual indications about a category type of the suggested search category.

9. The system of claim 1, wherein the processor is further configured to execute code for presenting a selected category along with a respective visual indication about a category type of the selected search category.

10. The system of claim 1, wherein the processor is further configured to execute code for updating the search input by replacing corresponding free text with a selected category, once a suggested category is selected.

11. The system of claim 1, wherein the processor is configured to execute code for extracting new search categories from a target database, and to add the new search categories to the hierarchic data structure.

12. The system of claim 1, wherein the processor is configured to execute code for:
identifying separate terms in a text related to an item presented in a website, and for each separate term calculating a frequency in which the term appears in the website in relation to the pre-defined search categories; and
adding terms with a frequency above a pre-defined threshold to the hierarchic data structure as new search categories in relation to the pre-defined search categories.

13. A method comprising:
receiving from a user machine a text input inserted as search input into a search input interface;
providing to the user machine at least one search category suggestion obtained from hierarchic data structure of search categories;
once a suggested search category is selected, adding an indication of the selected search category to the search input; and
providing at least one additional search category suggestion by filtering suggested search categories according to previously selected search categories included in the search input.

14. A system comprising a processor configured to execute a code for:
identifying separate terms in a text related to an item presented in a website, and for each separate term calculating a frequency in which the term appears in the website in relation to a pre-defined search category; and
adding to a database terms with a frequency above a pre-defined threshold as new search categories in relation to the pre-defined search categories.

15. A method comprising:
identifying separate terms in a text related to an item presented in a website, and for each separate term calculating a frequency in which the term appears in the website in relation to a pre-defined search category; and
adding to a database terms with a frequency above a pre-defined threshold as new search categories in relation to the pre-defined search categories.

16. A graphical user interface (GUI) for formulating a search query, the GUI comprising:
a search input interface to receive text input and selected search categories; and
a suggestion field configured to display and to receive a command for selection of at least one search category suggestions obtained from hierarchic data structure of search categories, wherein the at least one search category suggestions are consistent with search categories included in the search input field,
wherein the search input field is configured to display a selected suggested search category along with an indication of a corresponding category type based on the hierarchic data structure.

17. The GUI according to claim 16, wherein the suggestion field is configured to display each of the at least one search category suggestions along with an indication of a corresponding category type based on the hierarchic data structure.
